(19) United States
(12) Patent Application Publication
(10) Pub. No.: US 2025/0291326 A1
(43) Pub. Date: Sep. 18, 2025

(54) LIFECYCLE MANAGEMENT FOR PROCESSING ANATOMICAL MODELS

(71) Applicants: Steven A. Nelson, San Jose, CA (US); Giovanni Bisaccia, San Jose, CA (US); Scott Brewer, Castle Rock, CO (US); Robert Wesley, North Ridgeville, OH (US)

(72) Inventors: Steven A. Nelson, San Jose, CA (US); Giovanni Bisaccia, San Jose, CA (US); Scott Brewer, Castle Rock, CO (US); Robert Wesley, North Ridgeville, OH (US)

(73) Assignee: Ricoh Company, Ltd., Tokyo (JP)

(21) Appl. No.: 18/608,919

(22) Filed: Mar. 18, 2024

(51) Int. Cl. G05B 19/042

(52) U.S. Cl. CPC G05B 19/042

(57) ABSTRACT

Techniques for managing the lifecycle of processing 3D print orders are provided. In one technique, image data and a request to print a 3D model are received, from a requester computer, over a computer network, through a web portal. Segmentation instructions about segmenting the image data are also received. A record that indicates a print order that is based on the request and the segmentation instructions and that includes the image data is generated in a database. Later, the database is searched for the record based on first input from a segmenting computer that is different than the requester computer. Segmented image data that has been segmented based on the segmentation instructions are received from the segmenting computer.

### RELATED APPLICATION

This application is related to application Ser. No. 18/608,911, filed Mar. 18, 2024, entitled LIFECYCLE MANAGEMENT FOR PROCESSING ANATOMICAL MODELS and the contents thereof are incorporated by reference as if fully disclosed herein.

### TECHNICAL FIELD

The present disclosure relates generally to printing and, more specifically, to a 3D print portal to assist in approving 3D printable files.

### BACKGROUND

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

Technology for healthcare is a rapidly evolving market. Within this market, one of the quickest growing segments is the creation of patient-specific tools that help healthcare professionals personalize care to each individual. An example of a patient-specific tool is a 3D model, which is an exact replica of a specific part of a patient on which a surgeon will be operating. 3D models are beneficial in a number of ways. For example, surgeons can use 3D models to show patients exactly what will be operated on so that the patients are well informed. In addition, surgeons can use these models to plan their surgery and achieve better results including less time spent in operating rooms and less chance for errors. Yet, creating and obtaining a printed anatomical part or any object is often a time-consuming, manual, and expensive process.

### BRIEF DESCRIPTION OF THE DRAWINGS

In the drawings:

FIG. 1 depicts a networked computer system, according an embodiment;

FIG. 2A depicts an example requester client computing device, in an embodiment;

FIG. 2B depicts an example manager server computing device, in an embodiment;

FIG. 2C depicts an example reviewer client computing device, in an embodiment;

FIG. 3 is a flow diagram that depicts an example process for providing segmentation instructions for segmenting image (e.g., DICOM) data, in an embodiment;

FIGS. 4A-4B is a flow diagram that depicts an example process for printing a 3D anatomical model, in an embodiment;

FIGS. 5A-5B are example user interfaces of a web portal that is presented on a screen of the requester computer, in an embodiment;

FIG. 6 is a block diagram that depicts an example system architecture for printing 3D models, in an embodiment;

FIG. 7 is an example user interface that an image viewer or web application displays showing a virtual 3D model, in an embodiment;

FIG. 8 is an example process for uploading image data from an image viewer, in an embodiment;

FIG. 9 is an example process for approving a virtual 3D model in an image viewer, in an embodiment;

FIG. 10 is a block diagram that illustrates a computer system upon which an embodiment of the invention may be implemented.

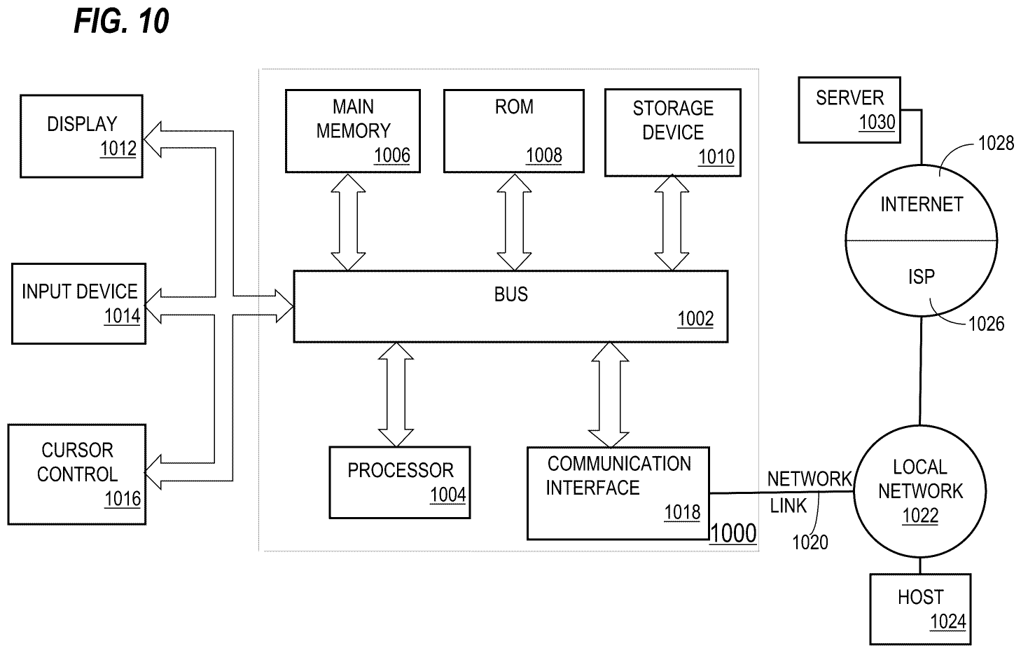

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.
I. OVERVIEW
II. ARCHITECTURE OVERVIEW OF A FIRST MAIN EMBODIMENT
   A. NETWORK
   B. REQUESTER SYSTEM
   C. REVIEWER CLIENT COMPUTING DEVICE
   D. DATA REPOSITORY
   E. IMAGE STORAGE
   F. MANAGER SERVER COMPUTING DEVICE
   G. 3D PRINTING DATA FLOW
III. ARCHITECTURE OVERVIEW OF A SECOND MAIN EMBODIMENT
   A. IMAGE SOURCE NETWORK
   B. IMAGE CLOUD
   C. PORTAL CLOUD
   D. SEGMENTATION NETWORK
   E. APPROVAL PROCESS
   F. EXAMPLE PROCESSES
IV. IMPLEMENTATION EXAMPLES

### I. Overview

According to various embodiments, computer-implemented apparatuses, methods, and systems are provided for an electronic portal that provides capabilities for processing orders for 3D anatomical models. In one technique, a server system receives, from a requester computer, through a web portal, DICOM data and a request to segment and print a 3D anatomical model based on the segmented DICOM data. The server system also receives segmentation instructions about segmenting the DICOM data. The server system causes a record to be generated in a database, the record indicating a print order that is based on the request and the segmentation instructions and that includes the DICOM data. Based on first input from a segmenting computer that is different than the requester computer, the server system searches the database for the record. The server system also receives, from the segmenting computer, second input that corresponds to the segmentation instructions and that specifies how to segment the DICOM data. The DICOM data is segmented based on the second input, resulting in a segmented version of the DICOM data.

In a related technique, based on first input received through a requester computer that includes a viewer of DICOM data, the DICOM data is received, from a requester system over a computer network. A record is generated in a database, the record indicating a print order that is based on the request and that includes the DICOM data. A request for data about 3D printing the DICOM data is transmitted to an entity associated with the requester system. Second input that includes instructions for segmenting the DICOM data is received, from the entity, through a web portal. The computer system that receives the DICOM data from the requester system may be different than the computer system that transmits the request.

Embodiments improve computer-related technology pertaining to generating 3D anatomical models. Embodiments allow healthcare professional users to have more flexibility in printing 3D anatomical models by pushing segmentation to the backend, freeing up time (in both performing the segmenting and learning electronic tools for segmenting) in segmenting DICOM data themselves. Technical benefits include case of obtaining an accurate 3D anatomical model leveraging new system architectures.

### II. Architecture Overview of A First Main Embodiment

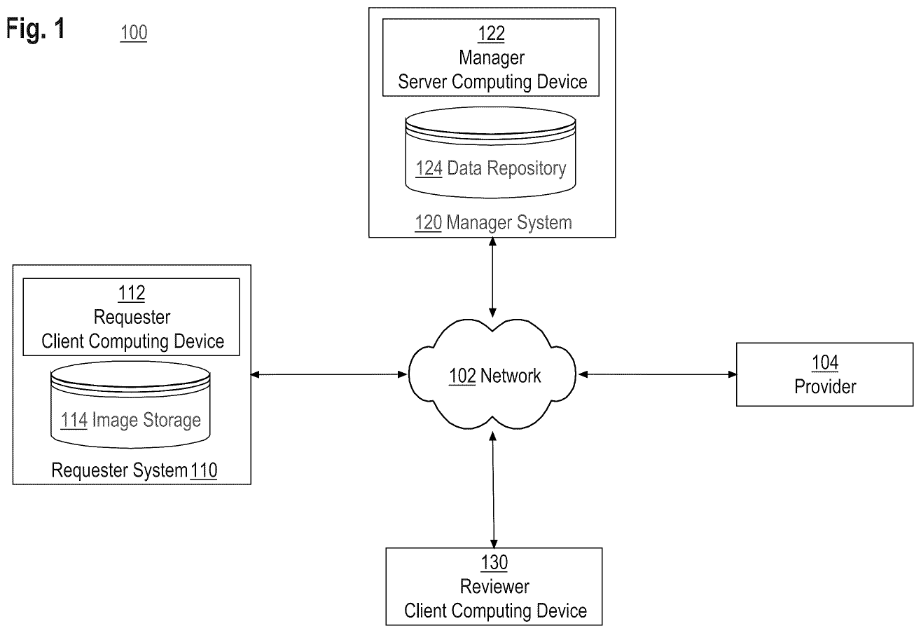

FIG. 1 depicts a networked computer system 100, according to an embodiment. In an embodiment, the computer system 100 comprises components that are implemented at least partially by hardware at one or more computing devices, such as one or more hardware processors executing program instructions stored in one or more memories for performing the functions that are described herein. All functions described herein are intended to indicate operations that are performed using programming in a special-purpose computer or general-purpose computer, in various embodiments. A “computer” or “computing device” may be one or more physical computers, virtual computers, and/or computing devices. As an example, a computer may be one or more server computers, cloud-based computers, cloud-based cluster of computers, virtual machine instances or virtual machine computing elements such as virtual processors, storage and memory, data centers, storage devices, desktop computers, laptop computers, mobile devices, and/or any other special-purpose computing devices. Any reference to “a computer” or “a computing device” herein may mean one or more computers, unless expressly stated otherwise. The instructions identified above are executable instructions and may comprise one or more executable files or programs that have been compiled or otherwise built based upon source code prepared in JAVA, C++, OBJECTIVE-C, or any other suitable programming environment.

Although components of FIG. 1 are depicted and described herein in one particular configuration, this is done for explanation purposes only and the components of FIG. 1 may be configured in any manner. In the example of FIG. 1, the networked computer system 100 includes one or more marketplace providers 104 (individually and collectively), one or more requester systems 110, a manager system 120, one or more reviewer client computing devices 130, all of which are communicatively coupled via a network 102.

FIG. 1 depicts only one of many possible arrangements of components configured to execute the programming described herein. Other arrangements may include fewer or different components, and the division of work between the components may vary depending on the arrangement. For example, as described below, image viewing may be performed on a requester client computing device 112, while viewing and segmenting DICOM images, and generating 3D printable files may be performed on a reviewer client computing device 130. However, image viewing, segmenting DICOM images, generating 3D printable files from segmented DICOM images, and/or viewing and modifying 3D printable files may be performed on a manager server computing device 122, in an embodiment. Embodiments are described here in the context of the DICOM standard for purposes of explanation, but embodiments are not limited to the DICOM standard and are applicable to other standards.

### A. Network

The network 102 broadly represents a combination of one or more local area networks (LANs), wide area networks (WANs), metropolitan area networks (MANs), global interconnected internetworks, such as the public internet, or a combination thereof. Each such network may use or execute stored programs that implement internetworking protocols according to standards such as the Open Systems Interconnect (OSI) multi-layer networking model, including but not limited to Transmission Control Protocol (TCP) or User Datagram Protocol (UDP), Internet Protocol (IP), Hypertext Transfer Protocol (HTTP), and so forth. All components described herein may be configured to connect to the network 102 and the disclosure presumes that all components of FIG. 1 are communicatively coupled via network 102. The various components depicted in FIG. 1 may also communicate with each other via direct communications links that are not depicted in FIG. 1 for purposes of explanation.

### B. Requester System

A requester system 110 comprises one or more requester client computing devices 112 and an image storage 114. Requester client computing device 112 may be implemented by any type of computing device. Example implementations of requester client computing device 112 include, without limitation, workstations, personal computers, laptop computers, tablet computers, personal digital assistants (PDAs), cellular telephony devices and any type of mobile devices.

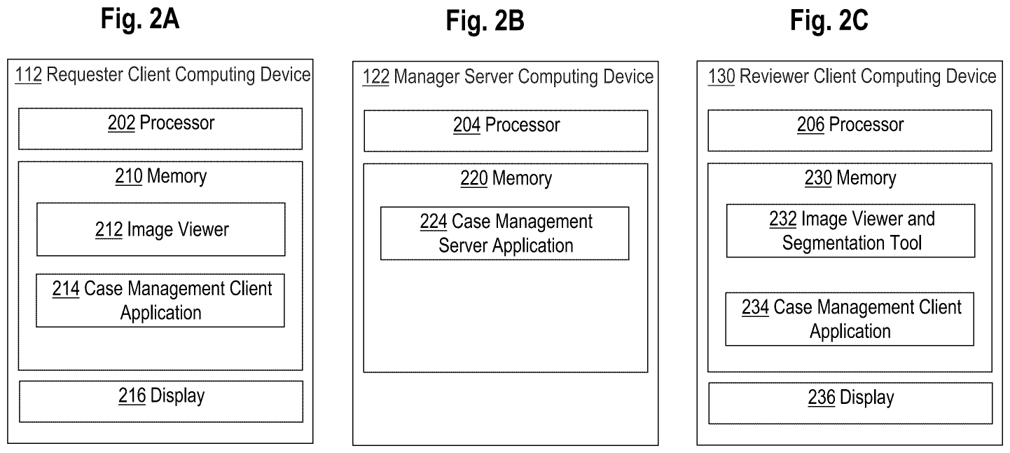

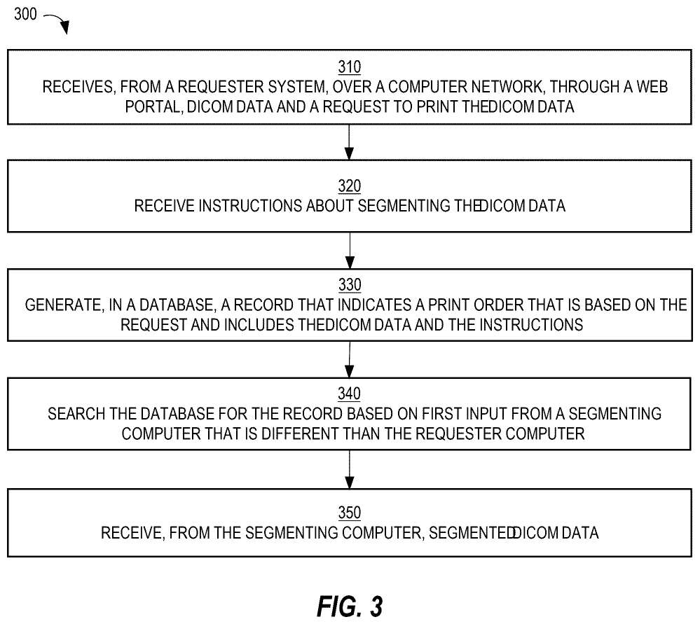

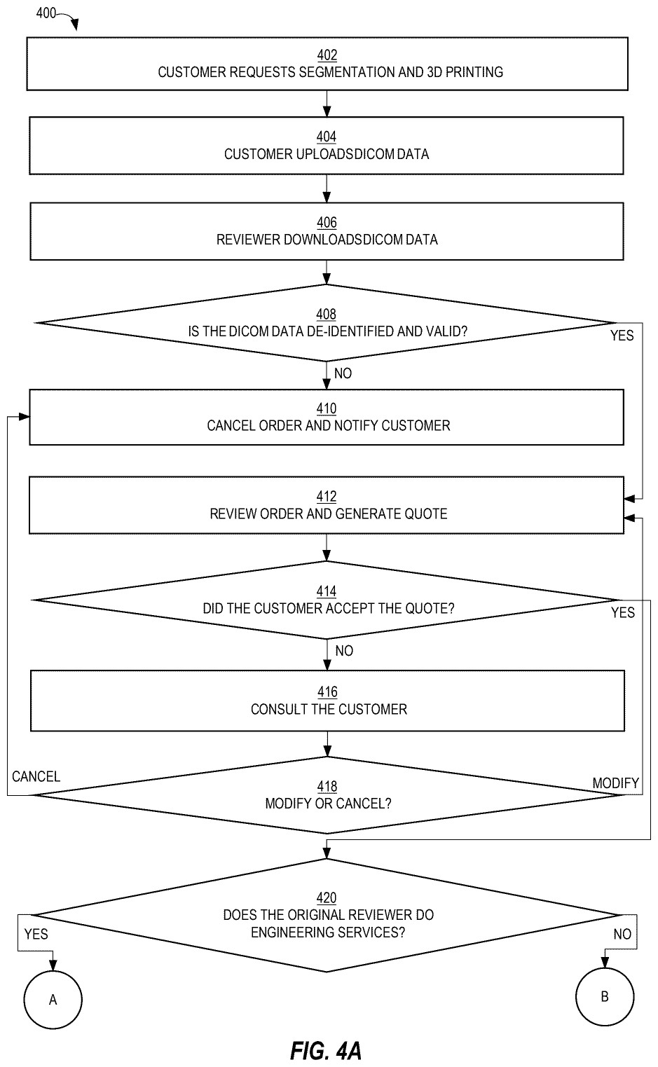

FIG. 2A depicts an example of Requester client computing device 112. Requester client computing device 112, operated by a healthcare professional user, includes a processor 202, a memory 220 that includes an image viewer 222 and a web application 224, and a display 226. Based on input from a user of requester client computing device 112, image viewer 222 allows the user to select DICOM images from image storage 114 and present the DICOM images on a screen of display 226. Based on input from a user of requester client computing device 112, web application 224 allows the user to select DICOM images from image storage 114, input other information (e.g., into one or more text fields), and transmit the DICOM images and the other information, over network 102, to manager system 120.

Case management client application 224 provides portal functionality that allows the healthcare professional of requester client computing device 112 to submit a 3D print request to manager system 120, transfer (e.g., upload) (and, optionally, view) data, such as DICOM images, and communicate with an application engineer user(s) (operating reviewer client computing device 130) regarding production requirements (e.g., messaging, video chatting, etc.). The 3D print request includes DICOM data. The print data may include a description of the object to be 3D printed, segmentation instructions, printing specifications, requester information, patient information, shipping information, billing information, or a combination thereof.

In an embodiment, case management client application 224 executes within a web browser and is provided by an entity associated with manager system 120. In this way, installation of application-specific client software on requester client computing device 112 is not required. For example, an embodiment may use a browser to communicate with a compatible HTTP server at the manager server computing device 122. For another example, an embodiment may use an application programming interface (API) to exchange data with a case management server application at the manager server computing device 122 without leaving image viewer 222. Examples of an API that may be implemented include an HTTP API, a REST API, and a Web API.

Image storage 114 of FIG. 1 may include one or more databases. Image storage 114 stores DICOM images and is accessible to a DICOM viewer, such as the requester client computing device 112. Thus, the DICOM viewer loads DICOM data from image storage 114 and presents the DICOM data on a screen of a computing device. The image storage 114 may be part of a patient archiving (PAC) system, which may be part of a hospital or group of hospitals.

### C. Manager System

Manager system 120 includes manager server computing device 122 and one or more data repositories 124. Manager server computing device 122 of FIG. 1 broadly represents one or more computers, such as one or more desktop computers, server computers, a server farm, a cloud computing platform (like Amazon EC2, Google Cloud, container orchestration (Kubernetes, Docker, etc.), or a parallel computer, virtual computing instances in public or private datacenters, and/or instances of a server-based application. In an embodiment, the manager server computing device 122 is in communication with requester system 110, one or more data repositories 124, and one or more reviewer client computing devices 130.

FIG. 2B depicts an example manager server computing device 122. Manager server computing device 122 includes a processor 204 and a memory 220 that includes a case management server application 224 executed by processor 204. The case management client applications 214, 234 executing on the client computing devices 112, 130 and the case management server application 224 executing on the manager server computing device 122 provide portal functionality that allows healthcare professional users and application engineer users to communicate with each other, to access and transfer data, etc., and version control functionality that allows healthcare professional users and application engineer users to access one or more versions of a collection of one or more 3D printable files.

The case management server application 244 of manager server computing device 122 may be organized using a plurality of instructions, such as interfacing instructions, verification instructions, receiving and sending instructions, storing and retrieving instructions, alerting instructions, approving instructions, transferring instructions, and performing instructions.

The interfacing instructions may be programmed to interface, using APIs, with one or more image viewer and segmentation tools 232, with one or more modification tools, and/or with one or more providers 104 to exchange data.

The verification instructions may be programmed to authenticate users of client computing devices 112, 130 (and by extension, client computing devices 112, 130) verifying authentication data (e.g., username/password) provided by the client computing devices 112, 130 against authentication information stored in the entity database.

The receiving and sending instructions may be programmed to transmit data with authenticated client computing devices 112, 130 and/or one or more providers 104. Example data being transmitted include messages between requester client computing device 112 and reviewer client computing devices 130, different versions of a collection of one or more 3D printable files, approval indications, alerts, notifications, etc.

The storing and retrieving instructions may be programmed to store data in and retrieve data from a data repository. For example, messages transmitted by client computing devices 112, 130 and different versions of a collection of one or more 3D printable files may be stored in data repository 124 of FIG. 1.

The transferring instructions may be programmed to transfer a new version of a collection of one or more 3D printable files to requester system 110 for review in response to receiving an instruction (e.g., a click) from reviewer client computing device 130.

The alerting instructions may be programmed to generate alerts, notifications, and emails to inform users of new data received. For example, an email may be generated and sent to a healthcare professional user informing the healthcare professional user that a new version of a collection of one or more 3D printable files is available for review. For another example, an email may be generated and sent to an application engineer user informing the application engineer user that feedback regarding the new version of the collection of one or more 3D printable files has been received.

The approving instructions may be programmed to “lock down” a particular version of the collection of one or more 3D printable files in response to receiving an approval indication for the particular version that has been approved by the healthcare professional user. The particular version may or may not be the latest version stored in data repository 124. When the particular version is locked down, the particular version may be visually differentiated from other versions of the collection.

The performing instructions may be programmed to perform a plurality of tasks. Some of the plurality of tasks may be performed prior to the particular version being locked down, while others may be performed after the particular version of the collection is locked down.

An example task performed prior to the particular version being locked down is causing to generate a digital quote data. The digital quote data defines an electronic quote for 3D printing. The digital quote data may be transmitted to requester client computing device 112, or to another computing device as specified in the print request, for approval prior to alerting the application engineer user of an initial version of the collection.

An example task performed after the particular version is locked down is causing to 3D print an object according to the particular version. Another example task performed after the particular version is locked down is causing to generate a digital invoice data. The digital invoice data defines an electronic payment invoice for the printed 3D object. The digital invoice data may be thereafter transmitted to requester client computing device 112, or to another computing device as specified in the print request.

Other tasks are contemplated. In an embodiment one or more tasks may be completed by one or more providers 104 of FIG. 1. For example, 3D printing may be completed by a 3D printing service provider, or invoicing may be completed by an accounting service provider.

### D. Data Repository

A data repository 124 of FIG. 1 may include one or more databases. As used herein, the term “database” refers to a corpus of data, organized or unorganized, in any format, with or without a particular interface for accessing the corpus of data.

Data repository 124 may include an entity database. The entity database includes records of entities (e.g., healthcare professional users, healthcare organizations associated with healthcare professional users, application engineer users, engineering organizations associated with application engineer users, etc.). Each entity record may be created in response to an entity account setup (e.g., registration with manager server computing device 122) and may contain contact information and authentication information for an entity.

Data repository 124 may include a case database. The case database includes records of cases. A case may refer to a medical matter or another type of matter. Each case record may be created in response to receiving a 3D print request submitted from the requester system 110 (e.g., the requester client computing device 112) and may contain DICOM data, print data, an initial version of a collection of one or more 3D printable files, any modified version of the collection of the one or more 3D printable files are stored in data repository 124, quote data (when generated), invoice data (when generated), and other information relating to the print request. Each case record of the case database may be associated with one or more entity records (e.g., record of requester and/or record of reviewer) of the entity database.

In an embodiment, the initial version of the collection of the one or more 3D printable files of an object may be provided at reviewer client computing device 130 or manager server computing device 122. Similarly, a modified version of the collection of the one or more 3D printable files of the object may be provided at reviewer client computing device 130 or the manager server computing device 122.

Data repository 124 may include one or more other databases storing additional information that may be used by one or more components of computer system 100. For example, data repository 124 may include a database used by a 3D print portal (described herein) to store production order and related information.

Databases may be co-located in a single data repository or may be separately located in different data repositories. Furthermore, although data repository 124 is shown in FIG. 1 as part of manager system 120, data repository 124 may be a component separate from other components of FIG. 1 or part of another component.

### E. Reviewer Client Computing Device

A reviewer client computing device 130 of FIG. 1 may be implemented by any type of computing device. Example implementations of reviewer client computing device 130 include, without limitation, workstations, personal computers, laptop computers, tablet computers, personal digital assistants (PDAs), cellular telephony devices and any type of mobile devices.

FIG. 2C depicts an example reviewer client computing device 130. Reviewer client computing device 130, operated by an application engineer user, includes a processor 206, a memory 230 that includes an image viewer and segmentation tool 232 and a case management client application 234 executed by processor 206, and a display 236.

Image viewer and segmentation tool 232 allows a user of reviewer client computing device 130 to view and segment medical images and to generate 3D printable files from segmented medical images in collaboration with requester system 110. An example of image viewer and segmentation tool 232 is Merge Universal Viewer. Medical images may include medical images of anatomies. An example of a medical image is a DICOM image. 3D printable files may be STL (Standard Tessellation Language or STereoLithography) files, 3MF (3D Manufacturing Format) files, or other files suitable for 3D printing.

Tool 232 may also allow an application engineer user of the reviewer client computing device 130 to view and modify 3D printable files, which may be STL files, 3MF files, or other files suitable for 3D printing.

Web application 234 allows a user of reviewer client computing device 130 to communicate with manager system 120, such as downloading DICOM data, uploading 3D printable files, and/or notifying manager system 120 that a quote, a segmentation, or a final draft of the 3D printable files are ready for review.

### F. Example Process

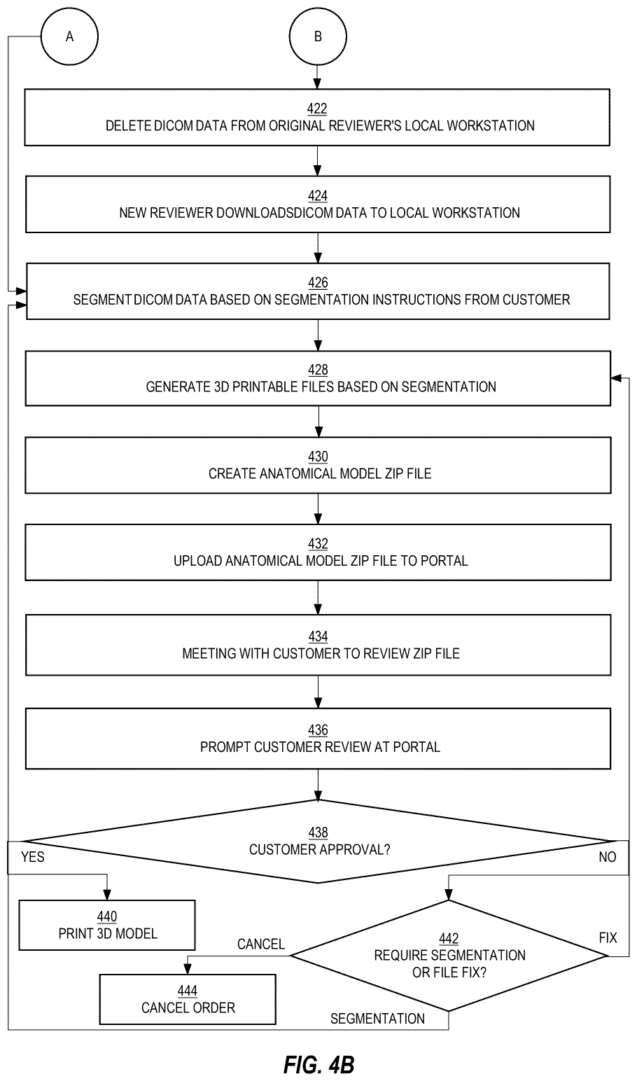

FIG. 3 is a flow diagram that depicts an example process 300 for providing segmentation instructions for segmenting image (e.g., DICOM) data, in an embodiment. Process 300 may be implemented by one or more components of manager system 120, such as manager server computing device 122.

At block 310, DICOM data and a request to print the DICOM data is received from a requester computer, over a computer network, through a web portal. An example of the requester computer is requester client computing device 112.

At block 320, instructions about segmenting the DICOM data is received. These segmentation instructions may have accompanied the DICOM data or may have been received separately from the print request, such as in a different communication channel, at a different time, and/or from a different computing device. The segmentation instructions may also be received with the web portal.

At block 330, a record that indicates a print order, that is based on the request and that includes the DICOM data and the segmentation instructions, is generated in a database. An example of the database is data repository 124. Block 330 may involve manager server computing device 112 calling an API of the database to create a record, populate appropriate fields of the record with the DICOM data, the segmentation instructions, and other data pertaining to the print request, and store the record in the database.

At block 340, the database is searched for the record based on first input from a segmenting computer that is different than the requester computer. An example of the segmenting computer is reviewer client computing device 130. The entity associated with the requester computer is different than the entity associated with the segmenting computer. The first input may be a series of inputs (e.g., query terms) that may be relative to a user interface provided by manager system 120 and that traverse the database, indicating a search for the record.

Block 340 may be preceded by a notification being transmitted to the segmenting computer or to a computing device associated with a user that operates the segmenting computer. The notification may include information about the print request. The notification may include a link that logically identifies the record or data that is associated with the record, such as a print request identifier, a patient identifier, a study identifier, and/or an accession identifier.

At block 350, segmented DICOM data is received from the segmenting computer. Block 350 may be preceded by the user/operator of the segmenting computing providing input to a segmentation tool that executes on the segmenting computer, the input corresponding to the segmentation instructions from the requester. Once the DICOM data is segmented, the user/operator provides input that causes the segmented DICOM data to be uploaded to manager system 120.

### G. 3D Printing Data Flow

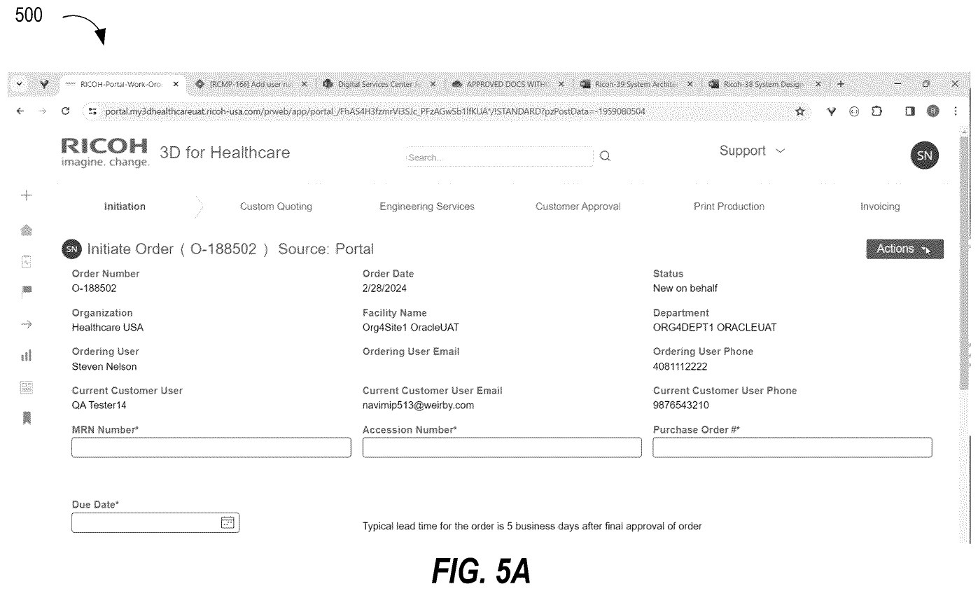

FIGS. 4A-4B is a flow diagram that depicts an example process 400 for printing a 3D anatomical model, in an embodiment. There are three main entities involved: requester system 110, manager system 120, and one or more reviewer client computing devices 130. Manager system 120 is affiliated with a (e.g., web) portal. Each block of process 400 may comprise one or more sub-steps or operations.

At block 402, a user requests segmentation and printing of a 3D model. Block 402 may involve the user operating reviewer client computing device 112 to point a web browser to a 3D print portal of manager system 120. This may involve the user entering a uniform resource locator (URL) or typing in a domain name of the 3D print portal into a text field of the web browser.

In response to the request, manager system 120 causes a web page to be presented on a screen of the user's computing device. The web page includes graphical elements that allow the user to enter data (e.g., into one or more text fields of the web page) and identify one or more DICOM files that are accessible to the user's computing device. For example, a user interface on a screen of the user's computing device allows a healthcare professional user to search DICOM files (that include DICOM images) based on patient and/or based on study. Example search criteria that a user may submit via the user interface include last name, first name, patient ID, accession number, date range of study, and modality. An accession number identifies a physician's order for an MRI or scan that results in the DICOM files. A physician's order may result in multiple scans; thus, multiple DICOM files may be associated with the same accession number. A study may have one or more series of scans.

In response to the performance of a search based on the search criteria, the user interface is updated to include a set of search results, each search result including a study date, a modality (e.g., CT scan), a patient name (here, the patient names are anonymized), a patient identifier (ID), a description, an accession, a referring physician, and a number of images. Any of the search results may be selected.

In an embodiment, each DICOM file is designed to be standalone. In other words, all the information needed to identify a DICOM file is embedded in the file's header. This information may be organized into four levels of hierarchy: patient, study, series, and instance. “Patient” is the person receiving the exam. “Study” is the imaging procedure being performed, at a certain date and time, in a hospital or health clinic. Regarding “series,” each study comprises multiple series. A series may represent the patient being physically scanned multiple times in one study, such as for MRIs. Alternatively, a series may represent a patient being scanned once and that data is reconstructed in different ways, such as for CT scans. Regarding “instance,” every slice of a 3D image is treated as a separate instance. In this context, “instance” is synonymous with the DICOM file itself.

At block 404, the user causes DICOM data (e.g., a DICOM file) to be uploaded to the 3D print portal. Block 404 may involve the user identifying a physical or logical storage location that is accessible to the user's computing device and where the DICOM data is stored. The user may then provide input (e.g., selecting a button in the web page of the 3D print portal) that initiates an upload of the DICOM data to the 3D print portal, resulting in the DICOM data being transmitted over a computer network to manager system 120.

In response to user selection of a print request option, multiple data items are transmitted to the 3D print portal. Examples of those data items include a patient ID, an accession number of a study, a study instance UID, a series instance UID, and a 3D model name. The 3D model name may be free text that is entered by the user/customer. The other data items may be automatically transmitted without any user input to specify them as part of the user selection of the print request option.

Manager system 120, upon receiving the DICOM data (and other data items that are related to the DICOM data), stores the DICOM data in data repository 124.

Block 404 may also involve the user/customer being presented with a user interface (or production order initiation form) and entering production order (PO) information. This may be performed in response to the transmission of a DICOM file to the 3D print portal. This user interface may also be provided by the 3D print portal. The PO information may include a shipping address, a billing address, a model type, an order number, and/or special handling instructions.

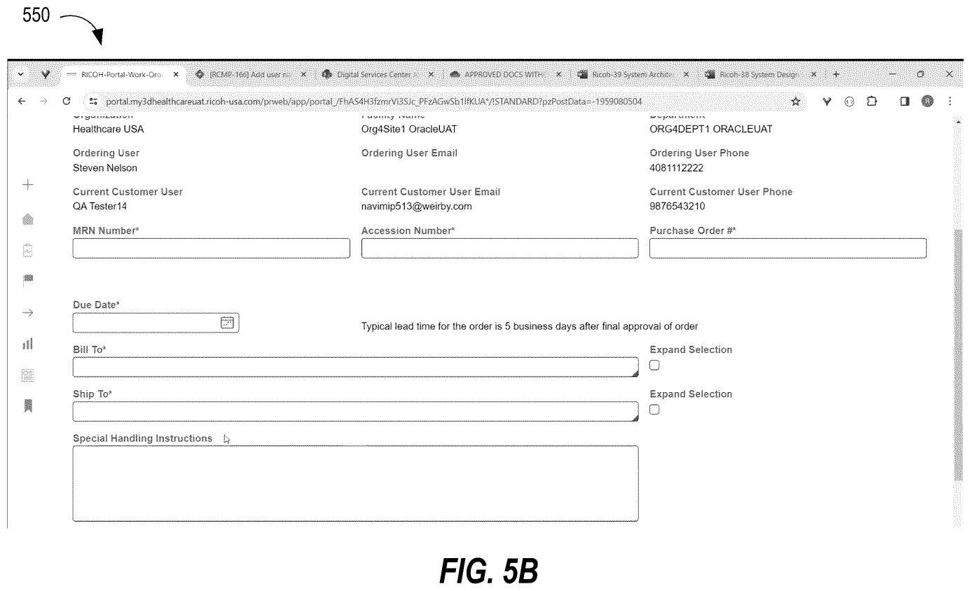

FIGS. 5A-5B are example user interfaces of a web portal that is presented on a screen of the requester computer, in an embodiment. User interface 500 includes pre-filled data about a 3D print order, such as order number, organization, ordering user, order date, etc. User interface 500 includes text fields for the user/customer to fill out, such as MRN number, accession number, purchase order number, and due date. User interface 550 is part of the same user interface as user interface 500, but also includes text fields for billing address, shipping address (to which to ship or mail a physical 3D model), and special instructions, including instructions on how to segment the DICOM data.

At block 406, a reviewer, such as a biomedical engineer, provides input that causes the DICOM data to be retrieved from manager system 120 and stored on a local workstation or computing device of the reviewer, such as reviewer client computing device 130. Block 406 may involve interacting with a user interface that is presented on a screen of the reviewer's computing device, that is provided by manager system 120, and that includes user interface (UI) controls for viewing and selecting DICOM data for download. The user interface may present multiple DICOM files from which to select, each DICOM file corresponding to a different patient, hospital, study, and/or accession number.

At block 408, it is determined whether the DICOM data is de-identified and valid. Block 408 may be performed automatically, manually, or partially automatically and partially manually. For example, the reviewer may manually view the DICOM data to determine whether all PMI (personal medical information), such as patient name, address, or contact information, is included in the DICOM data. As another example, a process executing on the reviewer's computing device analyzes the DICOM data to determine whether it contains PHI. Examples of invalid DICOM data include DICOM data that (a) does not contain certain fields (e.g., study ID, series ID, accession number, or patient id), (b) has attributes that do not conform to the DICOM specification, and (c) contains PHI that is not needed to create a 3D anatomical model.

If the determination in block 408 is negative, then process 400 proceeds to block 410. Otherwise, process 400 proceeds to block 412.

At block 410, the print order associated with the reviewed DICOM data is canceled and the user that initiated the print order (or an entity associated with the user) is notified of the canceling. Block 410 may involve the reviewer selecting a cancel option that is presented in a user interface that is provided by manager system 120 or another source. Alternatively, if block 408 is performed automatically, then block 410 may be performed automatically, whether fully or partially. For example, a notification may be sent automatically to manager system 120, which pushes a message to requester system 110. As another example, the reviewer selects an option in the user interface that triggers the sending of the notification. A notification may be an email message, a text message, or a software application message. The notification may include one or more reasons why the print order is canceled, such as the DICOM data including PMI or the DICOM data being invalid. The reasons may be specified by the reviewer or may be specified automatically by the process that detected the PMI or the invalid status of the DICOM data.

Block 410 may also involve deleting any DICOM data that is stored on the reviewer's computing device.

At block 412, the print order is reviewed and a quote is generated. Block 412 may be performed by the reviewer or may be performed automatically, such as by a machine-learned model that has been trained on past print orders that have been manually reviewed and manually quoted. As another example, a rules-based engine may accept details of the print order as input and, after applying multiple pre-defined rules, output a quote.

Block 412 may involve causing a quote message to be transmitted to requester system 110 or to an account associated with requester system 110, such as an email account of the user that initiated the print request. For example, the reviewer's computing device transmits the quote to manager system 120, which transmits a message to requester system 110, where the message invites a user of requester system 110 to visit the 3D print portal to obtain the quote. As another example, the reviewer's computing device sends a quote message to manager system 120, which generates and sends (a) a SMS message to a phone of the user, the SMS message containing the quote and/or (b) an email message to an email account of the user.

At block 414, it is determined whether the user (or associated entity) accepted the quote. Quote acceptance may involve the user selecting a link in an email message (or text message) that contains the quote. Alternatively, the user may log into the 3D print portal, providing credentials (e.g., a username and password) in order to view the quote and provide input to accept or reject the quote. If the determination of block 414 is negative, then process 400 proceeds to block 416; otherwise, process 400 proceeds to block 420.

At block 416, the user is consulted with to determine a reason for rejecting the quote. Block 416 may occur over a telephone call, a video conference, one or more exchanges of email messages, or one or more exchanges of text messages.

At block 418, it is determined whether to cancel the 3D print order or to modify the quote. For example, after discussion with the user/requester, the reviewer may determine to lower the quote. The discussion may reveal that the segmentation instructions are ambiguous, unclear, or inaccurate. If it is determined to modify the quote, then process 400 returns to block 412; otherwise process 400 returns to block 410.

At block 420, it is determined with the review performs engineering services, such as segmenting. If not, then process 400 proceeds to block 422; otherwise, process 400 proceeds to block 426. Block 420 may be performed automatically. For example, a program executing on manager computer 120 reads data that indicates whether the reviewer is able to perform those engineering services. The data may indicate that ability directly or indirectly.

At block 422, the DICOM data stored on the requester's computing device is deleted. Block 422 may be performed automatically in response to a negative determination in block 420. Alternatively, the reviewer manually selects the DICOM data for deletion.

At block 424, a different reviewer downloads the DICOM data to that reviewer's local workstation or computing device. The different reviewer's computing device may be similar to reviewer client computing device 130 in that the different reviewer's computing device also includes an image viewer and segmentation tool. Block 424 may involve notifying the different reviewer with an email message, text message, or software application message that prompts the different reviewer to log into the 3D print portal and provide input to select and download the DICOM data.

At block 426, the reviewer (whether the original reviewer or the different reviewer) provides input to segment the images in the DICOM data. Block 426 may involve the reviewer providing input to image viewer and segmentation tool 232 while a subset of the DICOM images are displayed. For example, segmentation tool 232 includes a user interface that allows the reviewer to select a mode from among multiple modes, such as a 3D printing mode, calcium scoring, curved MPR, 3D 6:1 Layout, and 3D 4:1 Layout. As a result of user selection of the 3D printing mode, the user interface is updated with segmentation options, including multiple navigation panes, one of which may provide a perspective of a 3D object (e.g., a human skull that is different than other perspectives of the same skull). Within a navigation pane, the user might select a portion of an image depicting the 3D object. Based on the selected portion, segmentation tool 232 segments that portion and updates a preview pane to present an example of what a 3D printed model might look like.

The input that the reviewer provides to segment the DICOM images may be based on segmentation instructions from the user/requester.

At block 428, the segmentation tool generates 3D printable files (such as STL files) that are based on the segmentation instructions that were input to the segmentation tool. Examples of tools that generate 3D printable files include 3matics and Magic.

At block 430, an anatomical model zip file is generated. The anatomical model ZIP file defines the anatomical model in terms of assemblies, STL files, and metadata. The STL files are the 3D printable files. The anatomical model ZIP file is created by a utility in (e.g., Authentise) ME software. The anatomical model ZIP file can also be created manually. Block 430 may also involve exporting the 3D printable files from one tool to another, such as from Materialise Mimics to either Materialise Magic or Materialise 3matic.

At block 432, the anatomical model zip file is uploaded to the 3D print portal. Thus, block 432 may involve transmitting, using a case management client application, the zip file from the reviewer's computing device to manager system 120.

At block 434, a meeting with the user/requester is conducted. This meeting may be conducted over telephone or over video conferencing, which allows both parties to review the anatomical model zip file together.

At block 436, the user/requester is prompted to visit the 3D print portal (e.g., using reviewer client computing device 112) to formally approve the anatomical model zip file. The prompt may be given orally during the meeting and/or may be transmitted (e.g., from manager system 120) to the user/requester's computing device via another messaging channel, such as email, text, or other channel.

At block 438, it is determined whether the user/requester provided approval. Approval may be given by the user through a user interface of the 3D print portal. The 3D print portal stores, in data repository 124, data that indicates whether the user provided approval. Such storage may trigger block 438. If the determination in block 438 is positive, then process 400 proceeds to block 440; otherwise process 400 proceeds to block 442.

At block 440, upon receiving approval, manager system 120 (e.g., via the 3D print portal) causes a 3D model to be printed. Block 440 may involve transmitting PO information to provider 104. Block 440 may be implemented using an API call from the manager system 120 to provider 104. The PO information may include the 3D printable files (e.g., STL files and associated metadata), shipping and billing addresses, contact person(s), portal order ID, pricing, order number, and a (proprietary) product code. Some of this PO information may have been automatically retrieved from storage (e.g., data repository 124) based on PO information previously entered manually. Some of the PO information may have been manually entered later, such as contact person(s) and product code. In an alternative embodiment, instead of an

API call, the PO information is manually entered into provider 104, including the 3D printable files (downloaded from data repository 124 and uploaded to provider 104). Provider 104 manufactures the 3D model according to the anatomical model zip file.

At block 442, which indicates that the user/requester did not approve, it is determined whether the print order should be canceled, whether the 3D printable files should be fixed, or whether the DICOM images should be re-segmented. The response from the user/requester through the 3D print portal may indicate one of these options. If the print order is to be canceled, then process 400 proceeds to block 444. If the 3D printable files should be fixed, then process 400 returns to block 428. If the DICOM images should be re-segmented, the process 400 returns to block 426.

At block 444, the print order is canceled and any files related to the print order are removed/deleted from the reviewer's computing device (e.g., reviewer client computing device 130). Block 444 may also involve deleting the corresponding DICOM data that may be stored in data repository 124.

### III. Architecture Overview of A Second Main Embodiment

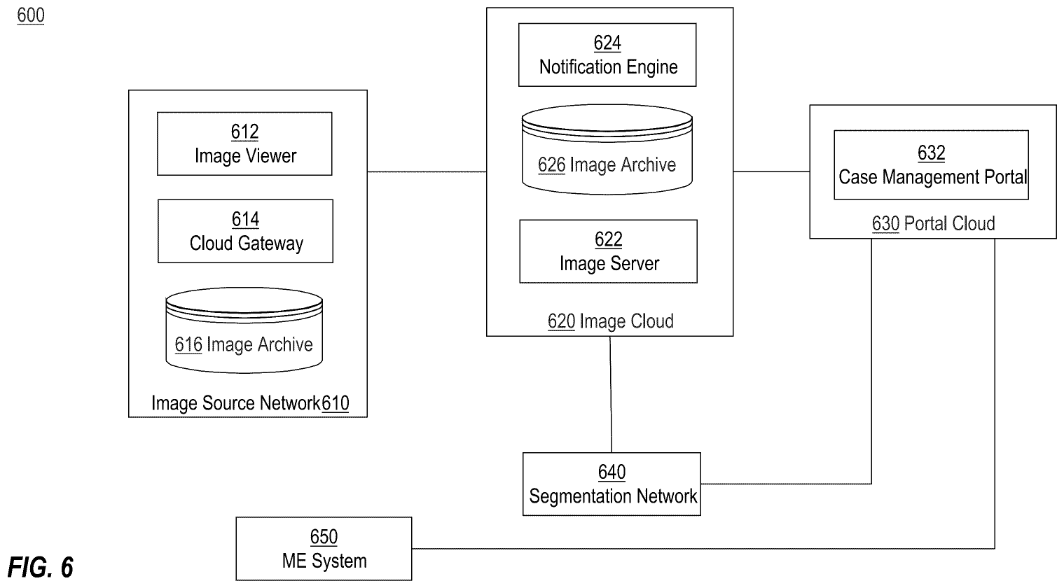

FIG. 6 is a block diagram that depicts an example system architecture 600 for printing 3D models, in an embodiment. Similar to networked computer system 100, system architecture 600 allows for segmentation to be performed remotely from the source of the image (e.g., DICOM) data. One difference between the first main embodiment and this second main embodiment is the latter's ease in transmitting image data from a source network to a target network.

System architecture 600 includes five main entities: an image source network 610, a image cloud 620, a portal cloud 630, a segmentation network 640, and a manufacturing engineering (ME) system 650. Each of these five entities may be connected via one or more computer networks, such as network 102.

Each entity comprises one or more components or elements. For example, image source network 610 includes an image viewer 612, a cloud gateway 614, and an image archive 616 that stores (e.g., DICOM) images on a per accession number or per study basis. Image cloud 620 includes an image server 622, a notification engine 624, and an image archive 626. On the other hand, portal cloud 630 and segmentation network only include a single component; portal cloud 630 includes a case management portal 632 and segmentation network 640 includes a workstation 642. Nevertheless, each of these entities may include more or less components than the ones depicted in FIG. 6.

While image cloud 620 and portal cloud 630 may be implemented as separate clouds, their respective components may be implemented in the same cloud. Also, references to “cloud” are example embodiments where the components are implemented in a cloud infrastructure, which may be managed by a third party. Alternatively, the components of the referenced “clouds” may be on-premise components that are (a) implemented at a location owned and operated by one or more organizations or enterprises and (b) not part of a third-party cloud infrastructure.

### A. Image Source Network

Image source network 610 may be a hospital network or a network of one or more clinics where images are generated for patients and initially stored. Image viewer 612 is a computing device that includes software for displaying image data, such as DICOM data. Although only a single image viewer 612 is depicted in FIG. 6, image source network 610 may include multiple image viewers 612. Image viewer 612 includes software (e.g., a plug-in) that presents a user interface for allowing a user (operating image viewer 612) to select a set of image data and cause it to be uploaded for 3D printing. The user interface may comprise a single button (or other graphical element) that is presented concurrently with a record pertaining to a set of image data. The button may appear whenever a record pertaining to a particular accession or study is being presented on a screen of image viewer 612. Selection of the button causes the corresponding set of image data to be transmitted to image cloud 620 via cloud gateway 614.

Additionally or alternatively, the user interface presents data about multiple sets of image data, e.g., pertaining to different accessions and/or different studies. The sets of image data may be filtered based on one or more criteria, such as MRI scans, CT scans, date range of creation of the set of image data, hospital department, insurance carrier, etc. Each set of image data is associated with a graphical element (e.g., a button or checkbox) that is adjacent thereto. If a button, then selection of the button causes the set of image data corresponding to the button to be uploaded to image cloud 620 via cloud gateway 614. If a checkbox, then the user operating image viewer 612 may select multiple checkboxes and then select a single button, causing multiple sets of image data to be uploaded to image cloud 620 via gateway 614.

In response to detection of a user's intention to transmit a set of image data to image cloud 620, image viewer 612 transmits, to cloud gateway 614, a request to transmit the set of image data. This request may include a medical record number (MRN) that uniquely identifies a patient, an accession number, a study identifier, and/or a server identifier that identifies image cloud 620 or image server 622.

Cloud gateway 614 receives the request and generates a request for the set of image data from image archive 616. This request may include a subset of the data that was included in the first request. Cloud gateway 614 transmits this request to image archive 616, which may be similar to image storage 114 in some respects. In response to receiving this request, image archive 616 retrieves the requested set of image data from storage and returns the set of image data to cloud gateway 614.

Cloud gateway 614 may then transmit two messages: a first message that includes the set of image data and any pertinent related metadata and a second message that notifies image cloud 620 of the print request. Cloud gateway 614 sends the first message to image server 622 and sends the second message to notification engine 624. Alternatively, cloud gateway 614 sends both messages to the same endpoint in image cloud 620, such as image server 622. Alternatively, cloud gateway 614 sends a single message that includes the content of both messages. In these last two examples, image server 622 performs multiple functions: both storing the DICOM data and notifying portal cloud 630.

### B. Image Cloud

In the embodiment where cloud gateway 614 sends two messages to different endpoints in image cloud 620, image server 622 receives the first message and causes the set of image data contained therein to be stored in image archive 626. Notification engine 624 receives the second message and generates a new message for portal cloud 630. The new message may contain the same information as the second message and additionally include other information, such as a server identifier that identifies image server 622 and an organization/site identifier. Portal cloud 640 will check the server identifier to determine if the server identifier is a valid server able to initiate orders. A valid server identifier is used to identify the source of the print order as organizations may have more than one image archive. The organization/site identifier is used to link (or associate) (a) the DICOM data and the associated order created to produce the 3D anatomical model with (b) an organization for security and billing purposes.

Image archive 626 may include a process that removes and/or replaces some image metadata, based on configuration settings. The configuration settings may specify DICOM attributes to remove to de-identify or correct the DICOM data. Some medical centers (e.g., hospitals) have devices that may generate DICOM attributes that do not conform to the DICOM specification. Different sources of image data may be associated with different configurations settings. For example, a hospital in one geographic location may have configuration settings that are different than configuration settings of a hospital in another geographic location.

### C. Portal Cloud

As described herein, portal cloud 630 receives a message from notification engine 624, the messaging including information about a 3D print request. The message may be an HTTP message or any type of message that may be exchanged between two different services executing in two different clouds. The different clouds may be hosted by the same cloud provider or by different cloud providers.

Case management portal 632 receives the message and, in response, causes a notification to be sent to image source network 610 or to an account associated with a user or computing device affiliated with image source network, such as image viewer 612. The notification may request certain information that a user/requester provides, such as input into a web form. The web form may be part of a web application that executes within a web browser installed on a computing device in image source network 610, such as image viewer 612. Examples of information that the user may provide include a ship-to-address, a bill-to-address, special instructions, segmentation instructions, model requirements, anatomy, pathology, surgery date, and a purchase order (PO) number. Case management portal 632 may support one or more policies for PO numbers depending on the organization's requirements. A PO policy may be one of the following:
a PO number is not required;
a PO number is required to be entered by the user for every print order;
each department has a PO number, which the portal displays to the user initiating the print order;
the organization has a blanket PO used for all print orders.

Once portal cloud 630 receives all necessary information from a customer regarding a print order in order to generate a quote, then a quote is determined, whether automatically or manually. For example, portal cloud 630 identifies print order data that is used to determine a quote and inserts that print order data into a machine-learned model that has been trained on based print orders and their corresponding manually-generated quotes. A user of portal cloud 630 may review an automatically-generated quote (and modify the quote) before sending the quote to the corresponding customer. Regardless of how a quote is determined, portal cloud 630 transmits the quote (via one or more communication channels) to the customer for approval. The customer may accept or reject a quote through a web application (from portal cloud 630) executing within a browser on a computing device of the customer. The computing device may or may not be within source image network 610 at the time of viewing and accepting/rejecting a quote.

Although not depicted in FIG. 6, portal cloud 630 may include a database that stores records, each record corresponding to a different print order. Each record may include a status of the print order, such as no notification of order creation sent yet, notification of order creation sent, awaiting additional data, quote generated, quote sent, await approval of quote, quote denied, image data not yet segmented, image data segmented, 3D printable files generated, awaiting approval of 3D printable files, 3D printable files rejected, meeting with customer scheduled, etc. Some print orders may be associated with a single status while other print orders may be associated with multiple complementary statuses.

### D. Segmentation Network

While FIG. 6 depicts segmentation network 640 as including only a single workstation, segmentation network 640 may include multiple workstations.

Once case management portal 632 receives the requested information from the user, then workstation 642 may proceed to download the corresponding image data for segmentation to proceed with the print order. Workstation 642 (or a user operator thereof) may be notified about the progress of the print order in one or more ways, such as an email message, a text message, or an application message. For example, workstation 642 may execute software that checks case management portal 632 regularly (e.g., hourly or daily) for pending print orders that have image data that has not yet been segmented. As another example, each workstation 642 or each user in segmentation network 640 may have an associated work queue. When a customer approves a quote of a print order, then case management 632 may assign that print order to a work queue of a user associated with segmentation network 640. If there are multiple users associated with segmentation network 640, then a print order may be assigned to a work queue manually or automatically, such as adding a print order to the work queue that has (a) the fewest outstanding print orders, (b) the fewest print orders that have not yet been segmented at least once, (c) the fewest print orders that have segmented image data that have not yet been approved/rejected, or (d) the prediction of being the fastest to deplete.

A user operating workstation 642 in segmentation network 640 provides input to workstation 642 that causes workstation 642 to generate and transmit a request to image cloud 620 (or image server 622 directly). Workstation 642 may establish a secure connection with image cloud 620 prior to transmitting the request, such as a virtual private network (VPN) connection. Software that is installed on workstation 642 may establish the connection. Alternatively, image server 622 acts as a front-end with which a web application, executing within a browser installed on workstation 642, interacts in order to retrieve data about one or more print orders, which data is stored in image archive 626.

The request from workstation 642 may include image identification data that uniquely identifies the set of image data in question relative to other sets of image data stored in image cloud 620 or image archive 626. For example, the image identification data may include an accession identifier, a study identifier, and a series identifier. Alternatively, the request may be a request to view all pending print orders or print orders that satisfy one or more criteria, such as print orders that are associated with a not-yet-segmented status. Even if the request implicitly (or explicitly) requests to view data about all print orders, the user may provide input that reduces the number of presented print orders. For example, the user may select one or more statuses that a print order must have or the user may specify an MRN, an accession number, and/or study identifier.

A user or engineer operating workstation 642 provides input to segmentation software executing on workstation 642, causing the software to segment the downloaded image data, resulting in one or more 3D printable files. (The segmenting may be similar/identical to the segmenting described herein with respect to the first main embodiment.) Such files may be stored/compressed in a zip file that the user causes to be transmitted to case management portal 632. Metadata associated with the zip file includes an MRN and an accession number. The process of transmitting the zip file to case management portal 632 is the user checking in.

### E. Approval Process

In response to receiving segmented image data from workstation 642 (e.g., in the form of a zip file), case management portal 632 causes the segmented image data to be stored in persistent storage. The persistent storage may be within portal cloud 630 or may be external to portal cloud 630. Case management portal 632 notifies image server 622 about the storage location of the segmented image data so that when the corresponding customer requests the segmented image data (e.g., from image source network 610) for review and evaluation (e.g., accept or reject), image server 622 knows where to retrieve the segmented image data. Case management portal 632 may also include, in the notification to image server 622, the MRN, accession number, study identifier, and series identifier associated with the segmented image data. Case management portal 632 may also send a notification to the user or organization indicating that the segmented image data is ready for review. The notification may be transmitted through one or more communication channels, including email, text, and/or notification engine 624 and cloud gateway 614.

In an embodiment, case management portal 632 maintains versioning data for each print order, the versioning data indicating a version of each segmented image data (or set of 3D printable files) for each print order. Thus, if image data has been segmented multiple times in different ways (e.g., in response to customer input that indicates dissatisfaction of an initial segmented version), then case management portal 632 stores versioning data with each set of image data pertaining to the same print order. Versioning data may include a version number (e.g., “1”, “2”, etc.) that is appended/prepended to a (e.g., zip) file name and, optionally, a timestamp indicating a date and/or time when the corresponding image data was segmented (or checked out for segmenting). In a related embodiment, case management portal 632 supports search functions that take into account version search criteria. For example, a search query for a version may include a search control that, when selected, indicates that the user submitting the search query is searching for the most recent version of segmented image data (whether for a particular print order or for multiple print orders). As a related example, a search query may specify a search control that indicates that the user is searching for the first version of segmented image data of a particular print order. As a related example, a search query may specify a particular version of segmented image data (e.g., the second version).

A user associated with image source network 610 and operating a computing device (e.g., image viewer 612 or another computing device) causes the computing device to transmit, to case management portal 632, a request for the segmented image data (e.g., or zip file that contains the segmented data). The request may be a URL that includes data that is associated with the zip file. The URL may have been included (e.g., embedded) in the notification that the user received from case management portal 632. Also, the request may include one or more credentials to authenticate the user and/or the computing device that the user is operating. In response to receiving the request, case management portal 632 causes content of the requested data (i.e., the segmented image data) to be presented on a screen of the user's computing device. Such causing may be through a web application that is executing within a browser of the computing device. Thus, any computing device that includes a browser may present a 3D model.

Alternatively to going through case management portal 632, the user associated with image source network 610 and operating an image viewer, such as image viewer 612, causes the image viewer to transmit a request to image server 622 through cloud gateway 614. The request includes data identifying the segmented image data (e.g., by accession number and study identifier). In response to receiving the request, image server 622 retrieves the segmented image data (based on the storage location data received from case management portal 632) and forwards the segmented image data (and any associated metadata) to the image viewer via cloud gateway 614.

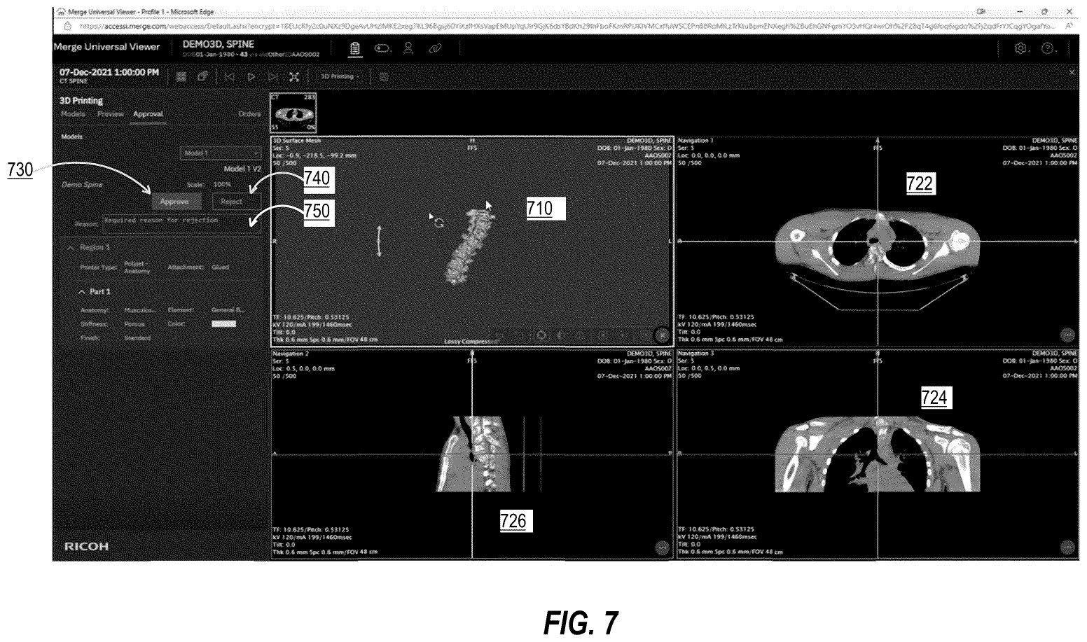

FIG. 7 is an example user interface 700 that an image viewer or web application displays showing a virtual 3D model, in an embodiment. The user interface includes an image 710 of the virtual 3D model, DICOM images 722-626 from which the 3D model is based, an approve button 730, a reject button 740, and a text field 750 for specifying reasons for rejecting the 3D model, if the user decides to reject the 3D model.

If the user selects approve button 730 or reject button 740, then the computing device transmits, to case management portal 632, data that indicates the approval/rejection and identification data that uniquely identifies the 3D model and/or the associated print order. If the user selects reject button 740 without specifying one or more reasons in text field 750 (e.g., without specifying a minimum number of characters in that text field), then user interface 700 may be updated to indicate that one or more reasons need to be provided for the rejection. In the case of a rejection, the text in text field 750 is also transmitted to case management portal 632 along with the data that identifies the version of the 3D model that the user rejected.

If the user approves of the 3D model, then case management portal 632 causes the 3D model to be printed at ME system 650. This causing may involve transmitting the corresponding set of 3D printable files (e.g., a zip file containing the 3D printable files) (and, optionally, other data, such as any data needed to complete the corresponding print order) to ME system 650 directly. Alternatively, this causing may involve transmitting a notification to an account associated with ME system 650, where the notification includes a storage location where ME system 650 may retrieve the set of 3D printable files. In response to receiving the notification, a user affiliated with ME system 650 may request, through a computing device that the user operates, the set of 3D printable files (and other data of the print order, such as a shipping address) from case management portal 632. ME system 650 manufactures a physical 3D model based on the 3D printable files and ships the physical 3D model to an address indicated in the print order.

If the user rejects the 3D model that is depicted in user interface 600 and provides reasons, then case management portal 632 may cause a notification to be transmitted to a user associated with the print order on the back end, such as an engineer that segmented the corresponding image data or a supervisor of that engineer. The user may re-segment the original image data or first reach out to the customer to clarify the reasons for the rejection. The re-segmented image data becomes a second version of the segmented image data.

### F. Example Processes

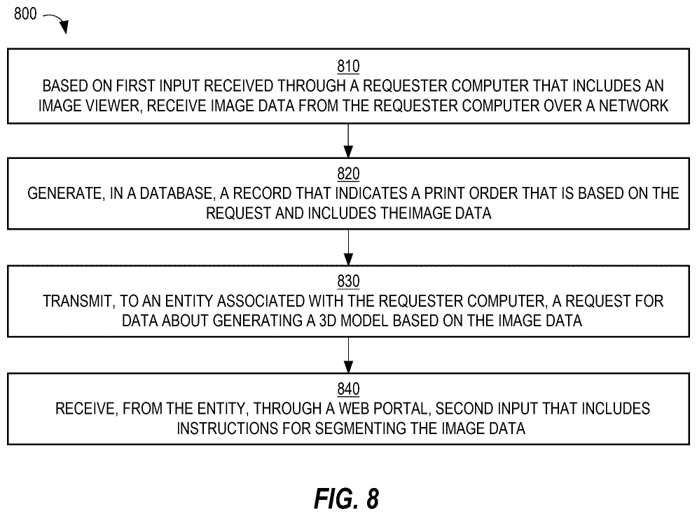

FIG. 8 is an example process 800 for uploading image data from an image viewer, in an embodiment. Process 800 may be performed by image server 622 and case management portal 632.

At block 810, image data is received, from a requester computer that includes an image viewer, over a network, based on first input received through the requester computer. The image viewer may be a DICOM image viewer that is capable of displaying DICOM images. The first input may be a selection of a button or other UI control that indicates an intention to upload a set of images. Block 810 may be performed by image server 622.

At block 820, a record is generated, in a database, that indicates a print order that is based on the request and that includes the image data. Block 820 may be performed by case management portal 632. The database may be stored local or remote from the entity that has access to the database.

At block 830, a request for data about 3D printing the image data is transmitted to an entity associated with the requester computer. Block 830 may be performed by case management portal 632. The request may be sent to the requester computer or to another computing device.

At block 840, second input that includes instructions for segmenting the image data is received, from the entity, through a web portal. The entity may be a user that is operating the image viewer or may be another user that is operating the same or different computing device. The second input may include other data about printing a 3D model based on the image data, such as shipping address, accession number, etc. Block 840 may also be performed by case management portal 632.

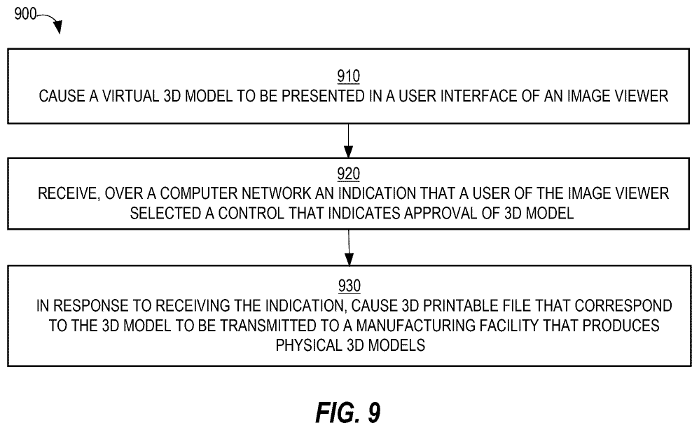

FIG. 9 is an example process 900 for approving a virtual 3D model in an image viewer, in an embodiment. Process 900 may be performed by image server 622 and case management portal 632.

At block 910, a virtual 3D model is caused to be presented in a user interface of an image viewer. The user interface also includes a first control for approving the virtual 3D model and a second control for rejecting the virtual 3D model. Block 910 may be performed by image server 622.

At block 920, an indication that a user of the image viewer selected the first control is received over a computer network. Block 920 may be performed by image server 622. Block 920 may also involve image server 622 notifying case management portal 632 about the approval.

At block 930, in response to receiving the indication, 3D printable files that correspond to the 3D model are caused to be transmitted to a manufacturing facility that produces 3D models. Block 930 may be performed by case management portal 632. The 3D printable files may be transmitted directly to the manufacturing facility or indirectly through one or more intermediaries, such as segmentation network 640.

### VI. Implementation Examples

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

For example, FIG. 6 is a block diagram that illustrates a computer system 600 upon which an embodiment of the invention may be implemented. Computer system 600 includes a bus 602 or other communication mechanism for communicating information, and a hardware processor 604 coupled with bus 602 for processing information. Hardware processor 604 may be, for example, a general purpose microprocessor.

Computer system 1000 also includes a main memory 1006, such as a random access memory (RAM) or other dynamic storage device, coupled to bus 1002 for storing information and instructions to be executed by processor 1004. Main memory 1006 also may be used for storing temporary variables or other intermediate information during execution of instructions to be executed by processor 1004. Such instructions, when stored in non-transitory storage media accessible to processor 1004, render computer system 1000 into a special-purpose machine that is customized to perform the operations specified in the instructions.

Computer system 1000 further includes a read only memory (ROM) 1008 or other static storage device coupled to bus 1002 for storing static information and instructions for processor 1004. A storage device 1010, such as a magnetic disk, optical disk, or solid-state drive is provided and coupled to bus 1002 for storing information and instructions.

Computer system 1000 may be coupled via bus 1002 to a display 1012, such as a cathode ray tube (CRT), for displaying information to a computer user. An input device 1014, including alphanumeric and other keys, is coupled to bus 1002 for communicating information and command selections to processor 1004. Another type of user input device is cursor control 1016, such as a mouse, a trackball, or cursor direction keys for communicating direction information and command selections to processor 1004 and for controlling cursor movement on display 1012. This input device typically has two degrees of freedom in two axes, a first axis (e.g., x) and a second axis (e.g., y), that allows the device to specify positions in a plane.

Computer system 1000 may implement the techniques described herein using customized hard-wired logic, one or more ASICs or FPGAs, firmware and/or program logic which in combination with the computer system causes or programs computer system 1000 to be a special-purpose machine. According to one embodiment, the techniques herein are performed by computer system 1000 in response to processor 1004 executing one or more sequences of one or more instructions contained in main memory 1006. Such instructions may be read into main memory 1006 from another storage medium, such as storage device 1010. Execution of the sequences of instructions contained in main memory 1006 causes processor 1004 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical disks, magnetic disks, or solid-state drives, such as storage device 1010. Volatile media includes dynamic memory, such as main memory 1006. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 1002. Transmission media can also take the form of acoustic or light waves, such as those generated during radio-wave and infra-red data communications.

Various forms of media may be involved in carrying one or more sequences of one or more instructions to processor 1004 for execution. For example, the instructions may initially be carried on a magnetic disk or solid-state drive of a remote computer. The remote computer can load the instructions into its dynamic memory and send the instructions over a telephone line using a modem. A modem local to computer system 1000 can receive the data on the telephone line and use an infra-red transmitter to convert the data to an infra-red signal. An infra-red detector can receive the data carried in the infra-red signal and appropriate circuitry can place the data on bus 1002. Bus 1002 carries the data to main memory 1006, from which processor 1004 retrieves and executes the instructions. The instructions received by main memory 1006 may optionally be stored on storage device 1010 either before or after execution by processor 1004.

Computer system 1000 also includes a communication interface 1018 coupled to bus 1002. Communication interface 1018 provides a two-way data communication coupling to a network link 1020 that is connected to a local network 1022. For example, communication interface 1018 may be an integrated services digital network (ISDN) card, cable modem, satellite modem, or a modem to provide a data communication connection to a corresponding type of telephone line. As another example, communication interface 1018 may be a local area network (LAN) card to provide a data communication connection to a compatible LAN. Wireless links may also be implemented. In any such implementation, communication interface 1018 sends and receives electrical, electromagnetic or optical signals that carry digital data streams representing various types of information.

Network link 1020 typically provides data communication through one or more networks to other data devices. For example, network link 1020 may provide a connection through local network 1022 to a host computer 1024 or to data equipment operated by an Internet Service Provider (ISP) 1026. ISP 1026 in turn provides data communication services through the world wide packet data communication network now commonly referred to as the “Internet” 1028. Local network 1022 and Internet 1028 both use electrical, electromagnetic or optical signals that carry digital data streams. The signals through the various networks and the signals on network link 1020 and through communication interface 1018, which carry the digital data to and from computer system 1000, are example forms of transmission media.

Computer system 1000 can send messages and receive data, including program code, through the network(s), network link 1020 and communication interface 1018. In the Internet example, a server 1030 might transmit a requested code for an application program through Internet 1028, ISP 1026, local network 1022 and communication interface 1018.

The received code may be executed by processor 1004 as it is received, and/or stored in storage device 1010, or other non-volatile storage for later execution.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. A computing system comprising:
one or more processors; and
one or more memories storing instruction which, when processed by the one or more processors, cause:
receiving, from a requester computer, over a computer network, through a web portal, image data and a request to print a 3D model;
receiving segmentation instructions about segmenting the image data;
generating, in a database, a record that indicates a print order that is based on the request and the segmentation instructions and that includes the image data;
searching the database for the record based on first input from a segmenting computer that is different than the requester computer; and
receiving, from the segmenting computer, segmented image data that has been segmented based on the segmentation instructions.

2. The computing system of claim 1, wherein the instructions, when processed by the one or more processors, further cause:
sending, to an entity associated with the requester computer, a notification that the segmented image data is available for viewing.

3. The computing system of claim 2, wherein the instructions, when processed by the one or more processors, further cause:
receiving, from the entity, a response, to the notification, that the segmented image data is approved.

4. The computing system of claim 2, wherein the instructions, when processed by the one or more processors, further cause:
after sending the notification, receiving, from the entity, a second request to establish a video conference to discuss the segmented image data.

5. The computing system of claim 1, wherein the instructions, when processed by the one or more processors, further cause:
receiving, through the web portal, order data that indicates a ship-to-address, 3D model requirements, an anatomy, and a pathology;
in response to receiving the order data, storing the order data in the record in the database.

6. The computing system of claim 1, wherein the first input or the second input includes credentials, wherein the instructions, when processed by the one or more processors, further cause:
based on the credentials received from the segmenting computer, determining whether to grant, to the segmenting computer, access to the image data.

7. The computing system of claim 1, wherein the instructions, when processed by the one or more processors, further cause:
sending, to an entity associated with the requester computer, a notification that includes a quote for printing a 3D model based on the image data and segmentation instructions;
receiving, through the web portal, an indication of whether a user associated with the requester computer accepts the quote.

8. One or more storage media storing instructions which, when executed by one or more processors, cause:
receiving, from a requester computer, over a computer network, through a web portal, image data and a request to print a 3D model;
receiving segmentation instructions about segmenting the image data;
generating, in a database, a record that indicates a print order that is based on the request and the segmentation instructions and that includes the image data;
searching the database for the record based on first input from a segmenting computer that is different than the requester computer; and
receiving, from the segmenting computer, segmented image data that has been segmented based on the segmentation instructions.

9. The one or more storage media of claim 8, wherein the instructions, when processed by the one or more processors, further cause:
sending, to an entity associated with the requester computer, a notification that the segmented image data is available for viewing.

10. The one or more storage media of claim 9, wherein the instructions, when processed by the one or more processors, further cause:
receiving, from the entity, a response, to the notification, that the segmented image data is approved.

11. The one or more storage media of claim 9, wherein the instructions, when processed by the one or more processors, further cause:
after sending the notification, receiving, from the entity, a second request to establish a video conference to discuss the segmented image data.

12. The one or more storage media of claim 8, wherein the instructions, when processed by the one or more processors, further cause:
receiving, through the web portal, order data that indicates a ship-to-address, 3D model requirements, an anatomy, and a pathology;
in response to receiving the order data, storing the order data in the record in the database.

13. The one or more storage media of claim 8, wherein the first input or the second input includes credentials, wherein the instructions, when processed by the one or more processors, further cause:
based on the credentials received from the segmenting computer, determining whether to grant, to the segmenting computer, access to the image data.

14. The one or more storage media of claim 8, wherein the instructions, when processed by the one or more processors, further cause:
sending, to an entity associated with the requester computer, a notification that includes a quote for printing a 3D model based on the image data and segmentation instructions;
receiving, through the web portal, an indication of whether a user associated with the requester computer accepts the quote.

15. A method comprising:
receiving, from a requester computer, over a computer network, through a web portal, image data and a request to print a 3D model;
receiving segmentation instructions about segmenting the image data;
generating, in a database, a record that indicates a print order that is based on the request and the segmentation instructions and that includes the image data;
searching the database for the record based on first input from a segmenting computer that is different than the requester computer; and
receiving, from the segmenting computer, segmented image data that has been segmented based on the segmentation instructions.

16. The method of claim 15, further comprising:
sending, to an entity associated with the requester computer, a notification that the segmented image data is available for viewing.

17. The method of claim 16, further comprising:
receiving, from the entity, a response, to the notification, that the segmented image data is approved.

18. The method of claim 16, further comprising:
after sending the notification, receiving, from the entity, a second request to establish a video conference to discuss the segmented image data.

19. The method of claim 15, further comprising:
receiving, through the web portal, order data that indicates a ship-to-address, 3D model requirements, an anatomy, and a pathology;
in response to receiving the order data, storing the order data in the record in the database.

20. The method of claim 15, further comprising:
sending, to an entity associated with the requester computer, a notification that includes a quote for printing a 3D model based on the image data and segmentation instructions;
receiving, through the web portal, an indication of whether a user associated with the requester computer accepts the quote.
